(19) United States
(12) Patent Application Publication
(10) Pub. No.: US 2007/0025547 A1
(43) Pub. Date: Feb. 1, 2007

(54) System and method for displaying visual information to communication system users

(76) Inventor: Nirnajan N. Segal, Arlington, TX (US)

Correspondence Address: MOTOROLA, INC., 1303 EAST ALGONQUIN ROAD, IL01/3RD, SCHAUMBURG, IL, 60196, US

(21) Appl. No.: 11/178,669

(22) Filed: Jul. 11, 2005

(51) Int. Cl. H04M 1/00

(52) U.S. Cl. 379/399.01

(57) ABSTRACT

An identity of at least one user (102) from a plurality of users (102, 104, and 120) that are associated with an ongoing call is determined. A visual tag is then displayed showing the identity of the user (102) for a substantial portion of the ongoing call. The identity is displayed to each of the plurality of users (102, 104, and 120) associated with the call.

### FIELD OF THE INVENTION

The field of the invention relates to displaying information to users of communication systems.

### BACKGROUND OF THE INVENTION

Telephony features are often related to and work in conjunction with the states of a call including the idle, incoming, active, and hold states. Recently developed features such as Multiple Line Appearance (MLA) and Shared Line Appearance (SLA) may use additional call states such as the Hold-P (i.e., a shared line partner has put the call on hold) and Active-P (i.e., a shared line partner is in the talk state) call states. In order for users to effectively utilize the features of the system, they frequently need to know both the identity of participants involved with the call and the current call state.

With regard to participant identification, some previous systems used caller identification (ID) features that briefly showed the identity of an originating user to a target user at the beginning of a call (i.e., during the alerting or ringing period). Specifically, a stored name and an incoming number association were used to determine the name of the originating caller during the ring cycle of the call. However, once the call was established, the name of the originating caller was no longer displayed.

As for call state information, some previous systems used a visual interface to display information to users. In one example, the interface included different blinking rates or multiple lights that represented distinct calls and these lights could be illuminated in different colors depending upon the state of the call.

While displaying some information relating to calls, these previous systems did not associate any of the call states with any of the parties involved in the call. Consequently, a user had to rely on their memory to remember the identity of the party and associated call state in order to effectively use many system features.

Another problem associated with previous systems was that certain types of information were not displayed. For example, in the case of the SLA feature, no differentiation existed between a call placed on hold by the user or some other user of the shared line and a call that was picked up by the user or another user of the shared line. In another example, no identification was made of the party that placed the call on hold, or the identities of any of the parties involved with the call. All of the above-mentioned problems created user confusion and frustration during the use of system features. Additionally, user security and privacy was compromised since users often did not know the identities of all users associated with a call.

### BRIEF DESCRIPTION OF THE DRAWINGS

FIG. 1 is a block diagram showing a system for presenting visual information according to various embodiments of the present invention;

FIG. 2 is a diagram of a flow chart and a diagram of a display of visual information according to various embodiments of the present invention;

FIG. 3 is a diagram of a flow chart and a diagram of a display of visual information according to various embodiments of the present invention;

FIG. 4 is a diagram of a flow chart and a diagram of a display of visual information according to various embodiments of the present invention;

FIG. 5 is a diagram of a flow chart and a diagram of a display of visual information according to various embodiments of the present invention;

FIG. 6 is a diagram of a flow chart and a diagram of a display of visual information according to various embodiments of the present invention;

FIG. 7 is a call flow diagram of an approach for displaying visual information according to various embodiments of the present invention;

FIG. 8 is a diagram of a flow chart and a diagram of a display of visual information according to various embodiments of the present invention; and

FIG. 9 is a call flow diagram of an approach for displaying visual information according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method for displaying visual tags or other information to users allows these users to view information concerning the state of the call and/or the identity of other users associated with the call throughout the duration of the call. The approaches described herein enable users to effectively utilize system features since users are not required to remember information in order to perform system functions. In addition, system security is enhanced since users are aware of the identity of all others associated with a call for the duration of the call.

In many of these embodiments, the identity of at least one user selected from a plurality of users that are associated with an ongoing call is determined. A visual tag or some other visual indication is then displayed showing the identity of the user for a substantial portion of the ongoing call. The identity is displayed to each of the plurality of users associated with the call.

In addition to the identity information, other types of information can be displayed to all users associated with the call. For instance, information can be displayed to each of the users indicating that the ongoing call is on hold. In another example, the identity of the party that placed the call on hold can be displayed. In yet another example, if in a group call, the identity of the current speaker involved in the call can be determined and this identity can be displayed. In still another example, during a conference call, the identity of the conference leader can be determined and displayed to each of the users.

Thus, approaches are described that visually present information to users associated with ongoing calls. The information can be utilized by these users to perform system functions. These approaches enhance user convenience and security since they do not require the user to remember call state or identity information in order to perform system functions and provide users with identification and/or call state information for the duration of the call.

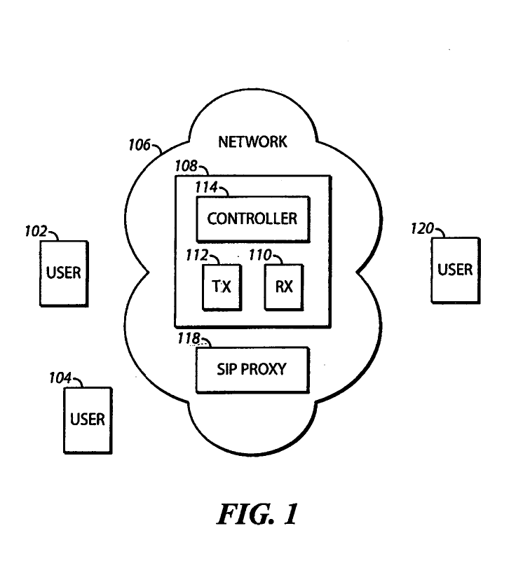

Referring now to FIG. 1, a block diagram of a system for providing visual information to a user is described. The system includes users 102, 104, and 120. Users 102 and 104 may be associated with the same organization (such as a corporation or a business) while the user 120 may not be associated with that organization. The users 102, 104, and 120 may be utilizing various types of communication equipment such as telephones, cell phones, personal computers, or personal digital assistants. The devices may be wireline (using, for instance, the H.323 protocol) or wireless (using, for example, the Session Initiation Protocol (SIP)). Other types of communication devices and protocols are possible. The communication devices associated with the users 102, 104, and 120 each include a display that provides visual information to the user using visual tags, lights, or any other type of visual display technology.

The users 102, 104, and 120 communicate with each other across various networks and interfaces such as a network 106. The network 106 may be any type of network or combination of networks. For instance, the network 106 may be the Plain Old Telephone System (POTS), a wireless network, the Internet, or some combination of these networks. Other examples of networks or combinations of these networks are possible.

The network 106 includes different types of devices that allow communications to occur. For instance, the network 106 includes a Public Branch Exchange (PBX) 108 and a Session Initiation Protocol (SIP) proxy server 118. The PBX 108 and proxy sever 118 allow users inside of the organization to communicate with users outside of the organization.

The PBX 108 includes a controller 114, receiver 110, and a transmitter 112. The controller 114 is programmed to determine the identity of each of a plurality of users that is associated with an ongoing call from information received at the input of the receiver 110 and to form and transmit visual display signals at the output of the transmitter 112. The visual display signals may represent a visual tag indicating the identity of each of the users associated with the call. The visual display signals are structured to be displayed on a display at the users 102, 104, or 120 for a substantial portion of the ongoing call. While described as being part of the PBX 108, it will be understood that these functions can be moved to other devices or spread across multiple devices. For instance, in certain systems using communication protocols such as SIP, it may be possible to convey (the visual tag) information directly between the two communicating devices (e.g., one SIP phone to another SIP phone) without the use of a controller.

In one example of the operation of the system of FIG. 1, the identity of at least one user from a plurality of users that are associated with an ongoing call is determined by the PBX 108. A visual tag is formed by the PBX 108, sent to the users 102, 104, or 120, and then displayed at a device associated with the users. The tag may show the identity of the user for a substantial portion of the ongoing call to each of the users 102, 104, and 120.

In addition, other types of information can be displayed to each of the users 102, 104, and 120 that are associated with the call. For instance, information can be displayed indicating that the ongoing call is on hold. Furthermore, the identity of the party that placed the call on hold can also be displayed. In another example, the identity of a speaker associated with the ongoing call can be determined by a speech recognition device located within the network 106 and this identity can be displayed to each of the users 102, 104, and 120. In still another example, when a conference call occurs, the identity of the conference leader of the ongoing call can be determined and displayed to each of the users 102, 104, and 120.

As mentioned, visual tags may be used to provide information to users concerning the identities of the other users (in addition to the call state information). For example, name tags identifying users can be used to enhance the currently used visual indications for the call states and/or replace the visual indications used for the additional call states.

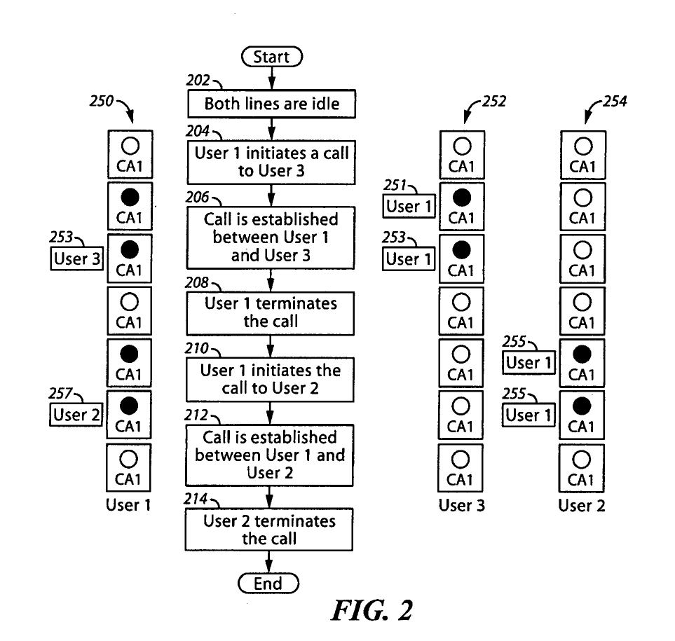

Referring now to FIG. 2, one example of an approach for presenting visual information to a user is described. This example shows the information displayed in conjunction with a two party dispatch or interconnect call that involves users User 1, User 3, and User 2 having displays 250, 252, and 254, respectively. In this example, the displays include a light and a display to present a visual tag. However, it will be understood that the type of display and the type of visual information presented by the display may be varied.

At step 202, the system is idle with no ongoing calls. As can be seen, displays 250, 252, and 254 are blank at this point. At step 204, User 1 initiates a call to User 3. On display 250 (User 1's display), the light is activated to indicate an active call. On display 252 (User 3's display), a tag 251 is displayed indicating User 1 is calling and the light is activated to indicate that a call is occurring. At this point, the display 254 (User 2's display) is still blank.

At step 206, the call is established between User 1 and User 3. A visual tag 253 is displayed at display 250 (User 1's display) indicating User 3 is involved with the call and the tag 251 is displayed at the display 252 (User 3's display) indicating that User 1 is involved with the call. The lights on the respective displays are also activated to indicate that an active call is in progress. The information (visual tags and activated lights) is displayed for substantially the entire duration of the call. Throughout this portion of the call, User 2's display remains blank since he is not involved with the call. At step 208, User 1 terminates the call and the displays are cleared.

At step 212, User 1 initiates a call to User 2. User 2's display 254 shows a tag 255 indicating User 1 is on the line. At step 212, a call is established between User 1 and User 2. A tag 257 is displayed at User 1's display 250 indicating User 2 is on the line and the tag 255 remains on User 2's display 254. At step 214, User 2 terminates the call and the displays are cleared.

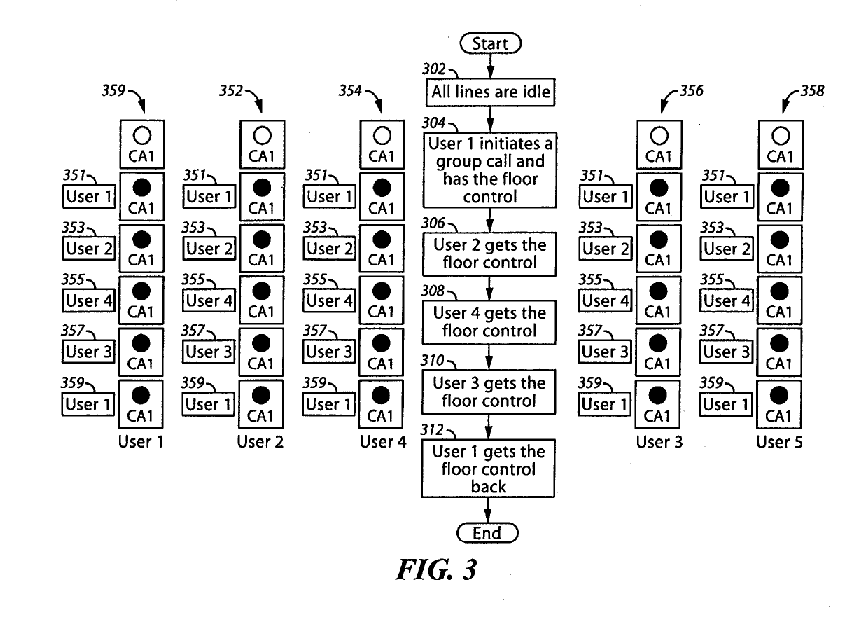

Referring now to FIG. 3, another example of an approach for displaying visual information to user is described. At step 302, all lines are idle and all the displays 350, 352, 354, 356, and 358 are blank. At step 304, User 1 initiates a dispatch group call and has floor control of the dispatch group call. All of the lights on the displays are activated to show that a group call is in progress. A tag 351 is also displayed to all the users showing User 1 has floor control.

At step 306, User 2 obtains floor control. All the lights on the displays continue to show that a group call is in progress. A tag 353 is also displayed to all of the users showing that User 2 has floor control. At step 308, User 4 gains floor control. All the lights on the displays continue to show that a group call is in progress. A tag 355 is also displayed to all the users showing User 4 has floor control.

At step 310, User 3 initiates a group call and obtains floor control. All the lights on the displays again show that a group call is in progress. A tag 357 is also displayed to all the users showing that User 1 has floor control. At step 304, User 1 again gains floor control. All the lights on the displays continue to show that a group call is in progress. A tag 359 is also displayed to all of the users showing that User 1 has floor control.

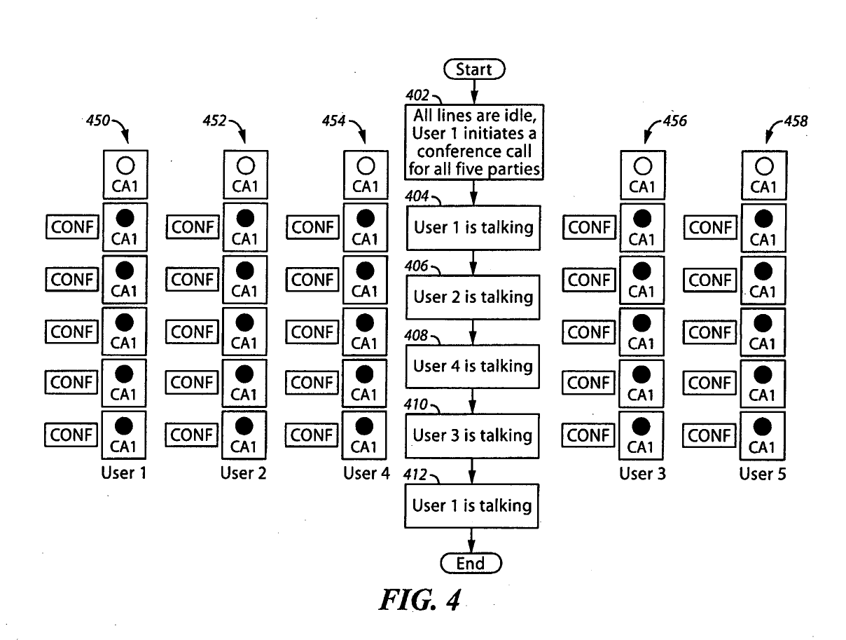

Referring now to FIG. 4, still another example of an approach for displaying visual information to a user is described. This example describes an interconnect conference call between users User 1, User 2, User 4, User 3, and User 5. A step 402, all lines are idle and User 1 initiates a conference call for all five parties. Nothing is displayed on the displays 450, 452, 454, 456, or 458. At step 404, User 1 is talking and a “Conf” tag 451 is displayed on all of the displays. At step 406, User 2 is talking and the tag 451 continues to be displayed. At step 408, User 4 is talking and the tag is 451 continues to be displayed. At step 410, User 3 is talking and the tag 451 remains displayed. At step 410, User 5 is talking, and the tag 451 continues to be displayed.

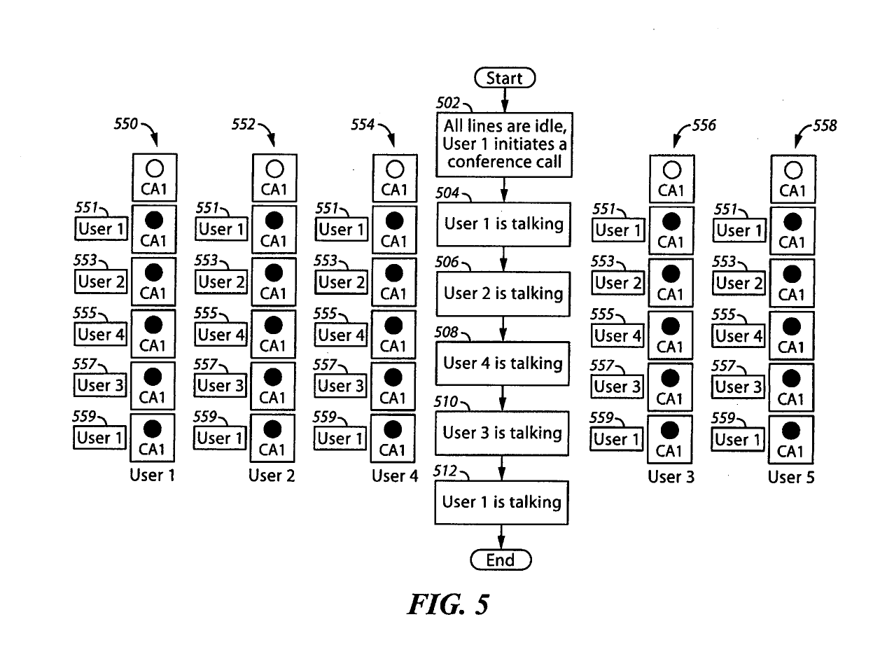

Referring now to FIG. 5, yet another example of an approach for displaying visual information to a user is described. In this example, users User 1, User 2, User 4, User 3, and User 5 are engaged in a conference call where speech recognition techniques are used to identify the speaker and display this information to all participants involved with the call. A step 502, all lines are idle and User 1 initiates a conference call for all five parties. Nothing is displayed on the displays 550, 552, 554, 556, or 558. At step 504, User 1 begins to speak and a tag 551 (identifying User 1) is displayed on all of the displays of the call participants. At step 506, User 2 begins speaking and a 553 tag identifying User 2 as the speaker is displayed. At step 508, User 4 is talking and a tag 555 is displayed identifying User 4 as the speaker. At step 510, User 3 begins speaking and a tag 557 is displayed identifying User 3. At step 410, User 1 again is talking, and a tag 559 is displayed identifying User 1 as the speaker.

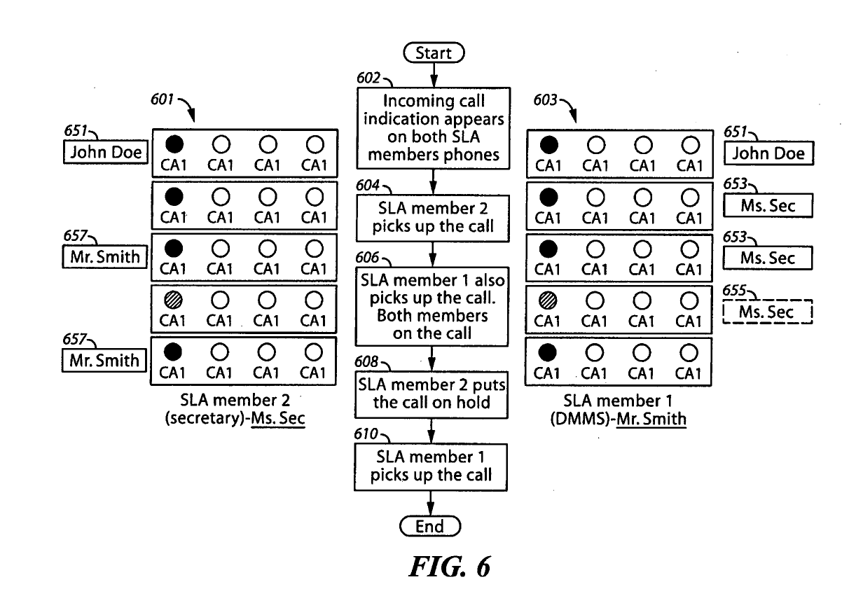

Referring now to FIG. 6, another example of an approach for displaying visual information to a user is described. In this case, an incoming call arrives and this is using the SLA feature. There are two SLA members: Ms. Secretary and Mr. Smith. At step 602, an incoming call indication appears on displays 601 and 603 on the phones of both SLA members. In this case a CL1 light is activated. A tag 651 is also displayed to show that User 5 Doe is calling. At step 604, the second SLA member (Ms. Secretary) picks up the call. On the display of Mr. Smith, a tag 653 is displayed showing Ms. Secretary picked the call up. At step 606, the first member (Mr. Smith) also picks up the call. The tag 653 (identifying Ms. Secretary as being associated with the call) continues to be displayed on the display 603 and, at this point, a tag 657 (identifying Mr. Smith as being associated with the call) is displayed on the display 601 of Ms. Secretary.

At step 602, the second member (Ms. Secretary) puts the call on hold. A new tag 655 of different color is displayed on the display 603 (of Mr. Smith) while the tag 657 is dropped. At step 610, the first SLA member (Mr. Smith) again picks up the call, Ms. Secretary drops the call, and the tag 657 returns to the display 601 of Ms. Secretary.

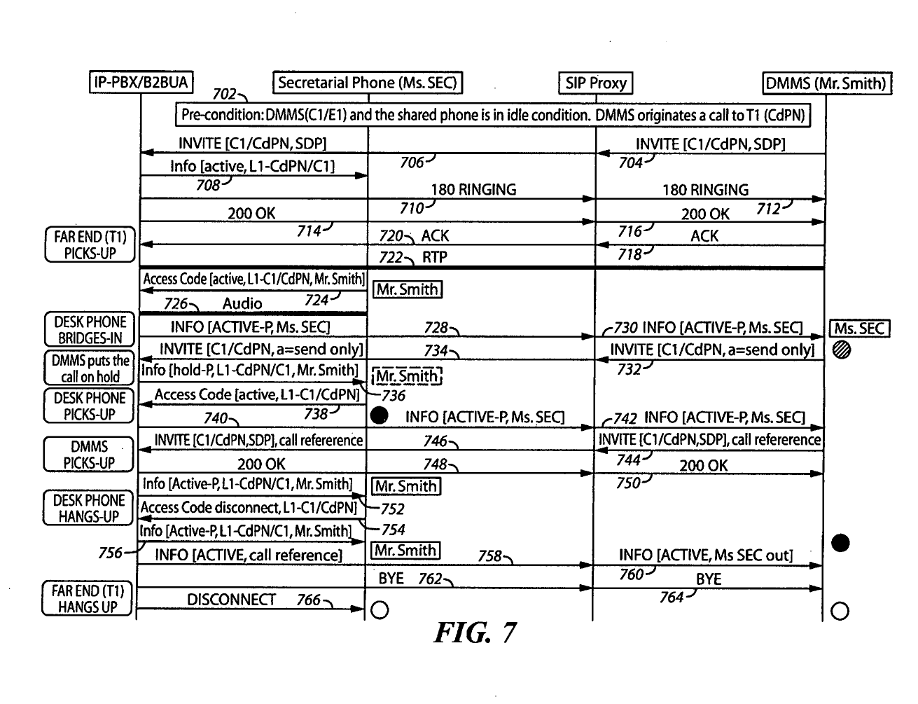

Referring now to FIG. 7, an example of an approach for displaying information to a user is described. This approach uses the new call states associated with the SLA feature and shows the use of the feature by users Mr. Smith (having a Dual Mode Mobile Station (DMMS) wireless phone) and Ms. Secretary (having a desk phone). At step 702, the phone is in the idle condition. At step 704, an INVITE message is sent from Smith to the SIP proxy. At step 706, the INVITE is sent from the SIP proxy to the PBX.

At step 708, information is sent from the PBX to the phone of Ms. Secretary. At step 710, a 180 Ringing message is sent from the PBX to the proxy and, at step 712, from the proxy to Smith. At step 714, a 200 OK message is sent from the PBX to the proxy and at step 716 from the proxy to Mr. Smith. At step 718, an ACK is sent from Mr. Smith to the proxy and, at step 720, from the proxy to the PBX. At step 722, the bearer (audio) path using the Real Time Protocol (RTP) is established.

At step 724, access code information is sent from the phone of Ms. Secretary to the PBX. At step 726, audio is established between the phone of the secretary and PBX. A “Smith” tag is displayed at the phone of Ms. Secretary. At step 728, the desk phone of Ms. Secretary bridges in and information is sent from the PBX to the SIP proxy. This information includes information indicating the current state of the call (i.e., Active-P). At step 730, this information is sent from the SIP proxy to Mr. Smith.

At step 732, an INVITE is sent from Mr. Smith to the proxy. At step 734, the INVITE is sent from the proxy to the PBX. At step 736, information is sent from the PBX to the secretarial phone. A “Smith” tag is displayed at the secretarial phone. At step 738, access code information is sent from Ms. Secretary to the PBX. At step 740, information is sent from the PBX to the proxy. This information includes the current state of the call (i.e., Active-P). At step 742, the information is sent from the proxy to Mr. Smith and a “Ms. Secretary” tag is displayed at the phone of Mr. Smith.

At step 744 an INVITE is sent from Smith to the proxy and, at step 746, from the proxy to the PBX. At step 748, a 200 OK message is sent from the PBX to the proxy and at step 750 from the proxy to Mr. Smith. This information includes the state of the call (Active-P). At step 752, information is sent from the PBX to the secretarial phone and, at step 754, access code information is sent from the secretarial phone to the PBX. At step 756, information is sent from the PBX to the secretarial phone where a “Smith” tag is displayed. At step 758, information is sent from the PBX to the proxy and, at step 760, from the proxy to Smith. The state of the call has now changed to Active.

At step 762, a BYE message is sent from the PBX to the proxy and at step 764 from the proxy to Mr. Smith. At step 766, a disconnect message is sent from the PBX to the proxy.

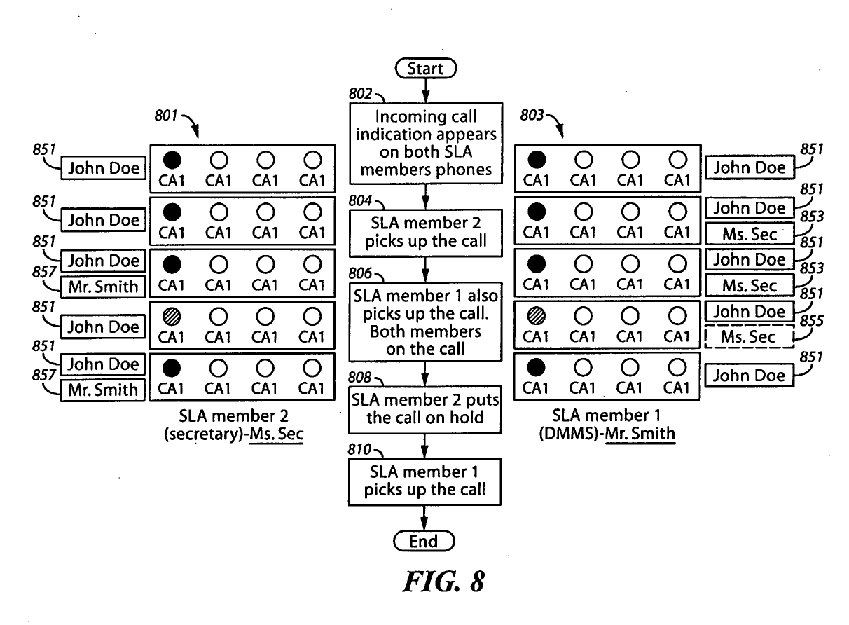

Referring now to FIG. 8, another example of an approach for displaying visual information to a user is described. In this case, two SLA members (Ms. Secretary and Mr. Smith) respond to an incoming call without using the new SLA call states. At step 802, an incoming call indication appears on displays 801 and 803 on the phones of both SLA members. In this case, a CA1 light is activated. A tag 851 is displayed to indicate that User 5 Doe is calling. At step 804, the second SLA member (Ms. Secretary) picks up the call. On the display of Mr. Smith, a tag 853 is displayed showing that Ms. Secretary picked up the call while the tag 851 continues to be displayed. At step 806, the first member (Mr. Smith) also picks up the call. The tag 853 (identifying Ms. Secretary) remains displayed on the display 803 and another tag 857 (identifying Mr. Smith) is displayed on the display 801 of Ms. Secretary. The tag 851 continues to be displayed on each of the displays.

At step 808, the second member (Ms. Secretary) places the call on hold. A new tag 855 of different color is displayed on the display 803 (of Mr. Smith) while the tag 857 is dropped. The tag 851 is still displayed. At step 810, the first SLA member (Mr. Smith) again picks up the call, Ms. Secretary drops the call, and the tag 857 is again presented on the display 801 of Ms. Secretary. The tag 851 continues to be displayed on both displays.

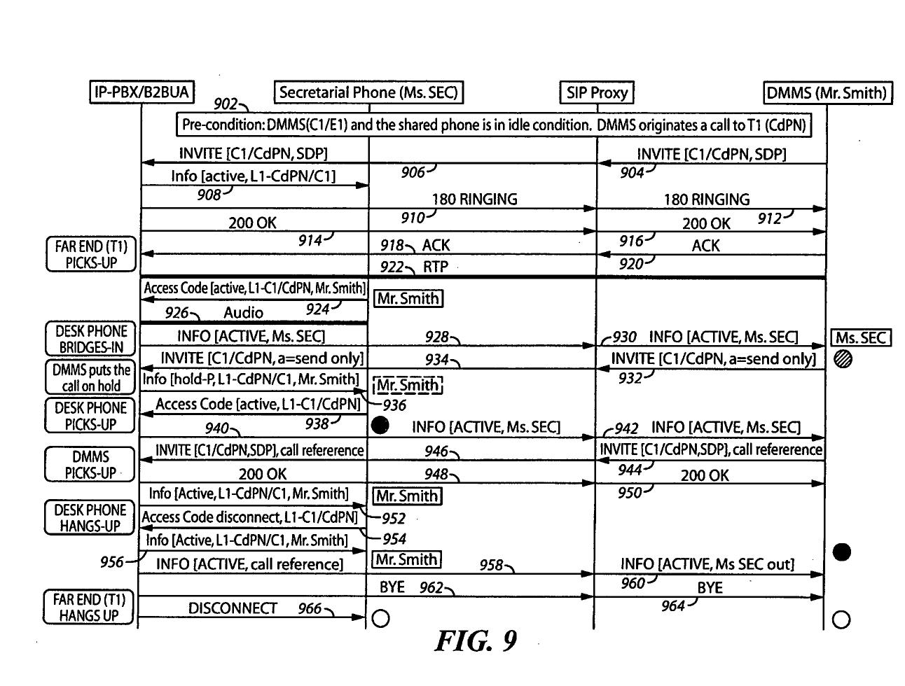

Referring now to FIG. 9, another example of an approach for displaying information to a user is described. This approach shows the use of the feature by users Mr. Smith and Ms. Secretary as name tags without using additional call states (Hold-P and Active-P as described elsewhere in this specification). At step 902 the system is idle. At step 904, an INVITE message is sent from Mr. Smith to a SIP proxy. At step 906, the INVITE is sent from the SIP proxy to a PBX.

At step 908, information is sent from the PBX to the phone of Ms. Secretary. The information indicates that the call state is currently Active. At step 910, a 180 Ringing message is sent from the PBX to the proxy and, at step 912, from the proxy to Mr. Smith. At step 914, a 200 OK message is sent from the PBX to the proxy and, at step 916, from the proxy to Mr. Smith. At step 918, an ACK is sent from Mr. Smith to the proxy and, at step 920, from the proxy to the PBX. At step 922, the bearer (audio) path using the Real Time Protocol (RTP) is established.

At step 924, access code information is sent from the phone of Ms. Secretary to the PBX. At step 926, an audio link is established between the phone of Ms. Secretary and PBX. A “Smith” tag is also displayed at the phone of Ms. Secretary. At step 928, the desk phone bridges in and information is sent from the PBX to the SIP proxy. This indicates the state of the call is Active. At step 930, the information is sent from the SIP proxy to Mr. Smith.

At step 932, an INVITE is sent from Mr. Smith to the proxy. At step 934, the INVITE is sent from the proxy to the PBX. At step 936, information is sent from the PBX to the secretarial phone. A “Smith” tag is displayed at the phone of Ms. Secretary. At step 938, access code information is sent from the secretary to the PBX. The state of the call is identified as Active. At step 940, information is sent from the PBX to the proxy. At step 942, the information is sent from the proxy to Mr. Smith and a “Ms. Secretary” tag is displayed at the phone of Mr. Smith.

At step 944 an INVITE is sent from Mr. Smith to the proxy and, at step 946, from the proxy to the PBX. At step 948, a 200 OK message is sent from the PBX to the proxy and at step 950 from the proxy to Mr. Smith. At step 952, information is sent from the PBX to Ms. Secretary and, at step 954, access code information is sent from the Ms. Secretary to the PBX. At step 956, information is sent from the PBX to the secretarial phone where a “Smith” tag is displayed. At step 958, information is sent from the PBX to the proxy and, at step 960, from the proxy to Mr. Smith. This information identifies the call state as Active.

At step 962, a BYE message is sent from the PBX to the proxy and at step 964 from the proxy to Mr. Smith. At step 966, a disconnect message is sent from the PBX to the proxy.

Thus, approaches are described that visually present various types of information to users associated with ongoing calls. The information can be utilized by these users to perform system functions. These approaches enhance user convenience and security since they do not require the user to remember call state and/or identity information in order to perform system functions.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of displaying identification information to a user comprising:
determining an identity of at least one user from a plurality of users that are associated with an ongoing call; and
displaying a visual tag showing the identity for a substantial portion of the ongoing call to each of the plurality of users associated with the call.

2. The method of claim 1 further comprising displaying information to each of the plurality of users indicating that the ongoing call is on hold.

3. The method of claim 2 further comprising displaying an identity of a party that placed the call on hold to each of the plurality of users.

4. The method of claim 1 further comprising determining an identity of a speaker associated with the ongoing call and displaying the identity of the speaker to each of the plurality of users.

5. The method of claim 1 further comprising determining an identity of a conferee of the ongoing call and displaying the identity of the conferee to each of the plurality of users.

6. A method of conducting a call between first and second users in a network comprising:
establishing a call between a first user and a second user; and
visually indicating to the first user for substantially the entire duration of the call an identity of the second user, and visually indicating to the second user for substantially the entire duration of the call an identity of the first user.

7. The method of claim 6 further comprising placing the call on hold and visually indicating that the ongoing call is on hold to the first and second users.

8. The method of claim 7 further comprising visually indicating an identity of a those users who are not the party that placed the call on hold.

9. The method of claim 6 further comprising determining an identity of a speaker associated with the ongoing call and visually indicating the identity of the speaker to at least one of the first and second users.

10. The method of claim 6 further comprising determining an identity of a conferee associated with the ongoing call and visually indicating the identity of the conferee to the first and second users.

11. The method of claim 6 further comprising determining an identity of an originating party and visually indicating the identity of the originating party to the first and second users.

12. A device for displaying identification information to users associated with a call comprising:
a receiver having an input;
a transmitter having an output; and
a controller coupled to the receiver and the transmitter, the controller being programmed to determine an identity of each of a plurality of users that is associated with an ongoing call from information received at the input of the receiver and to form and transmit visual display signals at the output of the transmitter, the visual display signals being representative of a visual tag indicating the identity of each of the plurality of users associated with the call and the visual display signals further being structured to be displayable for a substantial portion of the ongoing call at a display device at each of the plurality of users.

13. The device of claim 12 wherein the controller is further programmed to transmit information indicating that the ongoing call is on hold at the output of the transmitter.

14. The device of claim 13 wherein the controller is further programmed to transmit information indicating an identity of a party that placed the call on hold at the output of the transmitter.

15. The device of claim 12 wherein the controller is further programmed to transmit information representative of an identity of a speaker associated with the ongoing call at the output of the transmitter.

16. The device of claim 12 wherein the controller is further programmed to transmit information indicating an identity of a conferee associated with the ongoing call at the output of the transmitter.
